(19) United States
(12) Patent Application Publication
(10) Pub. No.: US 2026/0213089 A1
(43) Pub. Date: Jul. 23, 2026

(54) ELASTIC DOME

(71) Applicant: DARFON ELECTRONICS CORP., Taoyuan City (TW)

(72) Inventors: Chih-Hung Chien, Taoyuan City (TW); Po-Wei Tsai, Taoyuan City (TW); Chih-Chung Yen, Taoyuan City (TW)

(73) Assignee: DARFON ELECTRONICS CORP., Taoyuan City (TW)

(21) Appl. No.: 19/450,694

(22) Filed: Jan. 15, 2026

Related U.S. Application Data
(60) Provisional application No. 63/812,211, filed on May 27, 2025.
(60) Provisional application No. 63/795,654, filed on Apr. 28, 2025.
(60) Provisional application No. 63/747,962, filed on Jan. 22, 2025.

(30) Foreign Application Priority Data
Jan. 12, 2026 (TW) 115101043

(51) Int. Cl. H01H 13/04; H01H 13/14

(52) U.S. Cl. CPC H01H 13/04; H01H 13/14

(57) ABSTRACT

An elastic dome used in a keyswitch structure includes a bottom ring portion, a top ring portion, an outer oblique annular wall obliquely connecting the top ring portion and the bottom ring portion, a trigger post located inside the outer oblique annular wall, and an inner oblique annular wall extending obliquely downward from an inner side of the top ring portion to the trigger post. In an embodiment, the bottom ring portion has a narrowed upper portion and a lower portion connected to the upper portion. In another embodiment, when the elastic dome is compressed to a depressed state, the connection between the upper portion and the lower portion is higher than the connection between the top ring portion and a top conical surface of the inner oblique annular wall. In another embodiment, the inner oblique annular wall decreases in thickness from the top ring portion to the trigger post.

### CROSS REFERENCE TO RELATED APPLICATIONS

This application claims the benefit of U.S. Provisional Application No. 63/795,654, filed on April 28th, 2025. Further, this application claims the benefit of U.S. Provisional Application No. 63/812,211, filed on May 27th, 2025. Further, this application claims the benefit of U.S. Provisional Application No. 63/747,962, filed on January 22nd, 2025. The contents of these applications are incorporated herein by reference.

### BACKGROUND OF THE INVENTION

### 1. FIELD OF THE INVENTION

The present invention relates to a keyswitch structure, and more particularly to an elastic dome used in a keyswitch structure.

### 2. DESCRIPTION OF THE PRIOR ART

A keyboard is one of common input devices in electronic devices, logically consisting of many keys. Each keycap needs a return mechanism after being pressed. Some keys use rubber domes to provide the keycaps return force when the keycaps are pressed and to trigger the switches. The deformation characteristics of the rubber dome under stress have a decisive influence on the pressing tactile feel. The stress deformation curve of a typical rubber dome includes a peak and a valley. The switch triggering position of the rubber dome is usually located after the position corresponding to the valley value, which may result in the switch not being triggered effectively. Some keys also use springs to provide the keycaps return force when the keycaps are pressed. For example, in the FIG. 1C of US Patent No. 11,551,889 B2, the first and second linkage rods are arranged in a V-shape on the base plate and support the keycap, and the tension spring is placed horizontally with its two ends connected to the upper portions of the linkage rods. Whether using rubber domes or springs, a proper design is required to effectively provide functions of returning keycap and triggering switch.

### SUMMARY OF THE INVENTION

In view of the problems in the prior art, an objective of the invention is to provide an elastic dome, used in a keyswitch structure. A bottom ring portion of the elastic dome has a narrowed upper portion that participates in the elastic deformation of the elastic dome to increase the elastic dome's return force on a keycap of the keyswitch structure.

An elastic dome of an embodiment according to the invention is used in a keyswitch structure and includes a bottom ring portion, a top ring portion, an outer oblique annular wall, a trigger post, and an inner oblique annular wall. The bottom ring portion has a narrowed upper portion. The top ring portion is located above the bottom ring portion in a vertical direction. The outer oblique annular wall is located between the top ring portion and the bottom ring portion in the vertical direction. Two ends of the outer oblique annular wall are connected to the top ring portion and the upper portion of the bottom ring portion. The trigger post is located inside the outer oblique annular wall. The inner oblique annular wall extends obliquely downward from an inner side of the top ring portion and is connected to the trigger post. Thereby, when the elastic dome is compressed by a keycap of the keyswitch structure, the upper portion of the bottom ring portion, like the outer oblique annular wall, participates in the elastic deformation of the elastic dome, increasing a return force generated by the compressed elastic dome on the keycap.

An elastic dome of another embodiment according to the invention is used in a keyswitch structure and includes a bottom ring portion, a top ring portion, an outer oblique annular wall, a trigger post, and an inner oblique annular wall. The bottom ring portion has a narrowed upper portion and a lower portion connected to the upper portion. The top ring portion is located above the bottom ring portion in a vertical direction. The outer oblique annular wall is located between the top ring portion and the bottom ring portion in the vertical direction. Two ends of the outer oblique annular wall are connected to the top ring portion and the upper portion of the bottom ring portion. The trigger post is located inside the outer oblique annular wall. The inner oblique annular wall extends obliquely downward from an inner side of the top ring portion and is connected to the trigger post. The inner oblique annular wall has a top conical surface. Therein, when the elastic dome is compressed to a depressed state by a keycap of the keyswitch structure, a connection between the upper portion and the lower portion is higher than a connection between the top ring portion and the top conical surface in the vertical direction. Similarly, when the elastic dome is compressed by the keycap of the keyswitch structure, the upper portion of the bottom ring portion, like the outer oblique annular wall, participates in the elastic deformation of the elastic dome, increasing a return force generated by the compressed elastic dome on the keycap.

Another objective of the invention is to provide an elastic dome, used in a keyswitch structure. In the elastic dome, the inner oblique annular wall decreases in thickness from the top ring portion to the trigger post to ensure the portion of the inner oblique annular wall that first begins to bend during the compression of the elastic dome by a keycap of the keyswitch structure.

An elastic dome of an embodiment according to the invention is used in a keyswitch structure and includes a bottom ring portion, a top ring portion, an outer oblique annular wall, a trigger post, and an inner oblique annular wall. The top ring portion is located above the bottom ring portion in a vertical direction. The outer oblique annular wall is located between the top ring portion and the bottom ring portion in the vertical direction. Two ends of the outer oblique annular wall are connected to the top ring portion and the bottom ring portion. The trigger post is located inside the outer oblique annular wall. The inner oblique annular wall extends obliquely downward from an inner side of the top ring portion and is connected to the trigger post. The inner oblique annular wall has a maximum thickness at a portion connected to the top ring portion and a minimum thickness at a portion connected to the trigger post. Thereby, during a process of the elastic dome being compressed by a keycap of the keyswitch structure, in the inner oblique annular, the inner oblique annular wall will first bend at the portion of the inner oblique annular wall connected to the trigger post. This increases the deformation stability of the inner oblique annular wall, thereby increasing the reliability of the trigger post in triggering a switch of the keyswitch structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded view of a keyswitch structure according to an embodiment.

FIG. 2 is a sectional view of an elastic dome of the keyswitch structure in FIG. 1.

FIG. 3 is a schematic diagram illustrating the elastic dome in FIG. 2 when it is compressed until the trigger post begins to contact a switch circuit board.

FIG. 4 is a schematic diagram illustrating the elastic dome in FIG. 3 when it is compressed until the inner oblique annular wall begins to elastically deform.

FIG. 5 is a schematic diagram illustrating the elastic dome in FIG. 4 when it is compressed to a depressed state.

FIG. 6 is a schematic diagram illustrating a variation of the elastic dome in FIG. 2.

FIG. 7 is a schematic diagram illustrating another variation of the elastic dome in FIG. 2.

FIG. 8 is a schematic diagram illustrating a stress deformation curve of the elastic dome in FIG. 1.

### DETAILED DESCRIPTION

Directional terms mentioned in the following embodiments, such as up, down, left, right, front or back, etc., are only for reference to the directions in the attached drawings. The prefixes of component names, such as first, second, ..., etc., are only used to distinguish components and facilitate description, and do not impose other restrictions on the components themselves; furthermore, components with the same prefix in various embodiments do not necessarily correspond. The correspondence of components in each embodiment should still depend on the specific structure described in each embodiment.

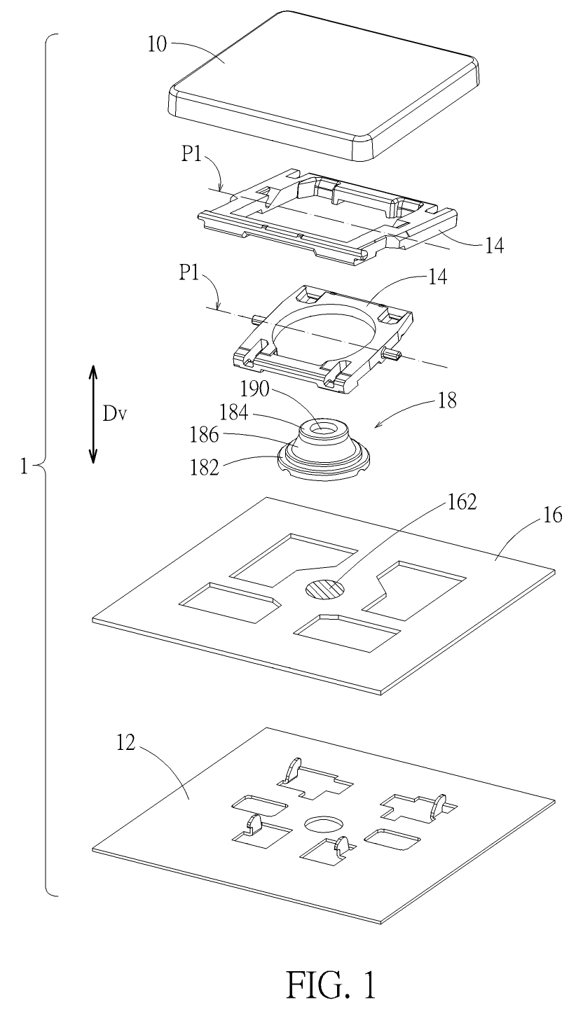

Please refer to FIG. 1. A keyswitch structure 1 according to an embodiment includes a keycap 10, a base plate 12, two supports 14, a switch circuit board 16, and an elastic dome 18. The keycap 10 is located above the base plate 12 in a vertical direction Dv (indicated by a double-headed arrow). The two supports 14 are pivotally connected around a pivot axis P1 (indicated by a chain in the figure). The two supports 14 are connected to the keycap 10 and the base plate 12 to support the keycap 10 above the base plate 12, so that the keycap 10 can move up and down (e.g., parallel to the vertical direction Dv) relative to the base plate 12 through the two supports 14. The switch circuit board 16 is stacked on the base plate 12. The switch circuit board 16 may be, but is not limited to, a membrane circuit board having a switch 162 (indicated by a circle filled with oblique lines in the figure), roughly aligning with the center of keycap 10. The elastic dome 18 is disposed on the switch circuit board 16 corresponding to the switch 162 and located under the keycap 10. When a user presses the keycap 10, the keycap 10 moves downward and compresses the elastic dome 18, causing the elastic dome 18 to trigger the switch 162. Then, when the user releases the keycap 10, the elastic dome 18 returns to its original state, pushing the keycap 10 back to its original position. In addition, in structural logic, the combination of the base plate 12 and the switch circuit board 16 can be regarded as a base of the keyswitch structure 1; in practice, the base can further include other structures.

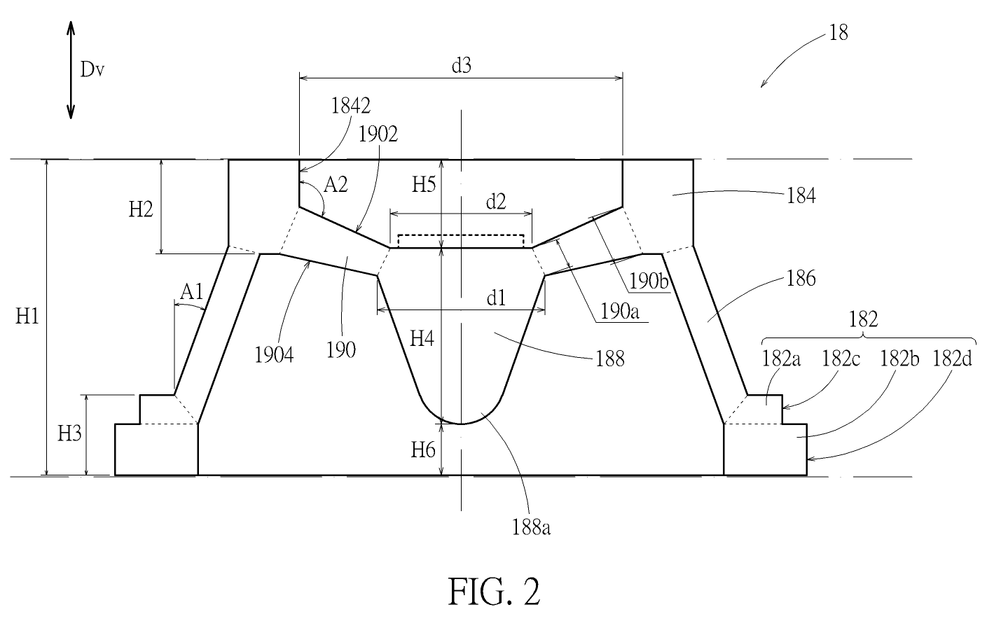

Please also refer to FIG. 2. FIG. 2 is a sectional view of the elastic dome 18; therein, hatching lines are not shown in FIG. 2 to facilitate the identification of the components of the elastic dome 18. The elastic dome 18 includes a bottom ring portion 182, a top ring portion 184, an outer oblique annular wall 186, a trigger post 188, and an inner oblique annular wall 190; the extent of each component is indicated by dashed lines in FIG. 2. A top surface of the top ring portion 184 will abut against a bottom surface of the keycap 10 (indicated by a chain line in the figure). A bottom surface of the bottom ring portion 182 will abut against a top surface of the switch circuit board 16 (indicated by a chain line in the figure). The top ring portion 184 is located above the bottom ring portion 182 in the vertical direction Dv. The outer diameter of the bottom ring portion 182 is greater than the outer diameter of the top ring portion 184. The outer oblique annular wall 186 is located between the top ring portion 184 and the bottom ring portion 182 in the vertical direction Dv. The outer oblique annular wall 186 extends obliquely downwards and outwards from the top ring portion 184 to the bottom ring portion 182. The outer oblique annular wall 186 as a whole is a downwardly expanding conical enclosure wall (i.e., a tubular structure that is narrow at the top and wide at the bottom), with its two ends (i.e., the upper and lower circular ends of the outer oblique annular wall 186) connected to the top ring portion 184 and the bottom ring portion 182, respectively. The outer oblique annular wall 186 extends substantially with a single thickness. The outer oblique annular wall 186 has an inclined angle A1 relative to the vertical direction Dv. The inclined angle A1 is between 15 and 30 degrees. This structural configuration helps the outer oblique annular wall 186 to deform uniformly during the compression of the elastic dome 18 by the keycap 10, increasing the stability of the deformation of the outer oblique annular wall 186. The bottom ring portion 182 has a narrowed upper portion 182a and a lower portion 182b connected to the upper portion 182a in the vertical direction Dv; that is, structurally, the outer diameter of the bottom ring portion 182 decreases in the upward direction. The outer oblique annular wall 186 is connected to the upper portion 182a. The trigger post 188 is located inside the outer oblique annular wall 186. The elastic dome 18 is axially symmetrical, and the central axis of the elastic dome 18 is indicated by a chain line in FIG. 2. Trigger post 188 is located on and extends along the central axis. The trigger post 188 has a distal portion 188a and triggers the switch 162 through the distal portion 188a.

The inner oblique annular wall 190 extends obliquely downward from the inner side of the top ring portion 184 to connect to the trigger post 188. The inner oblique annular wall 190 as a whole is a shallow saucer-shaped ring structure. The inner oblique annular wall 190 does not extend with a single thickness. Therein, the inner oblique annular wall 190 has a maximum thickness 190b (shown by the labeled structural thickness in the figure) at the portion connected to the top ring portion 184 and a minimum thickness 190a (shown by the labeled structural thickness in the figure) at the portion connected to the trigger post 188; the minimum thickness 190a is less than the maximum thickness 190b. Furthermore, in the embodiment, the inner oblique annular wall 190 gradually thins from the top ring portion 184 to the trigger post 188. Thereby, during a process of the elastic dome 18 being compressed by the keycap 18, in the inner oblique annular wall 190, the inner oblique annular wall 190 will first bend at the portion of the inner oblique annular wall 191 connected to the trigger post 188, which increases the deformation stability of the inner oblique annular wall 190, thereby increasing the reliability of the trigger post 188 in triggering the switch 162. Furthermore, the minimum thickness of 190a is greater than the wall thickness of the outer oblique annular wall of 186. The inner oblique annular wall 190 has a top conical surface 1902 and a bottom conical surface 1904. The connection between the top conical surface 1902 and the trigger post 188 is higher than the connection between the bottom conical surface 1904 and the top ring portion 184 in the vertical direction Dv. The top ring portion 184 has an inner wall surface 1842. The inner wall surface 1842 and the top conical surface 1902 form an included angle A2, which is between 90 degrees and 180 degrees.

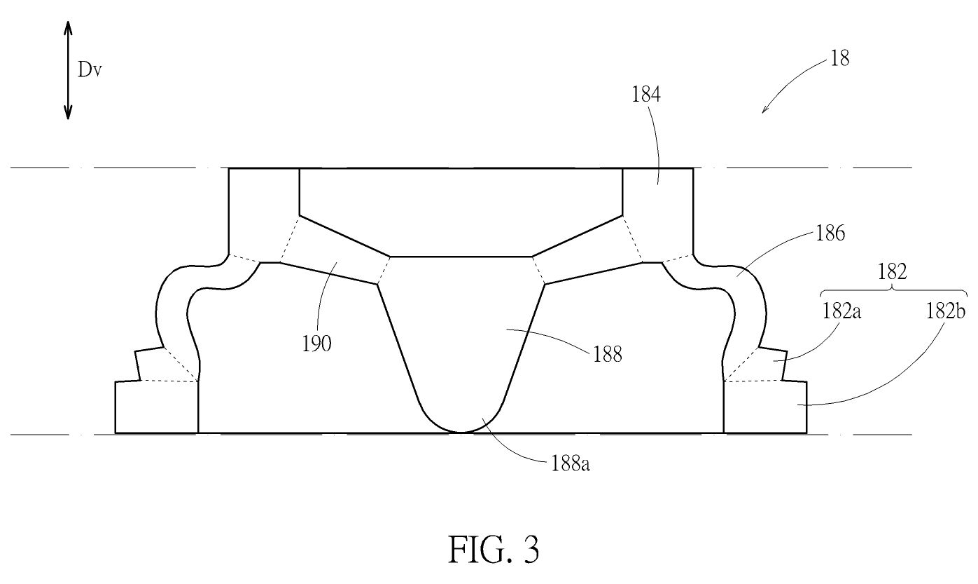

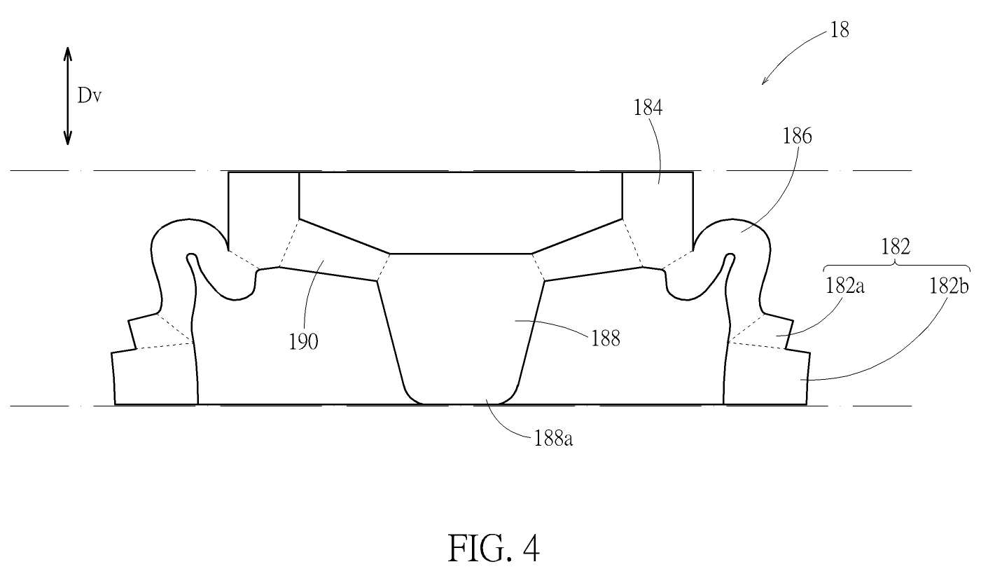

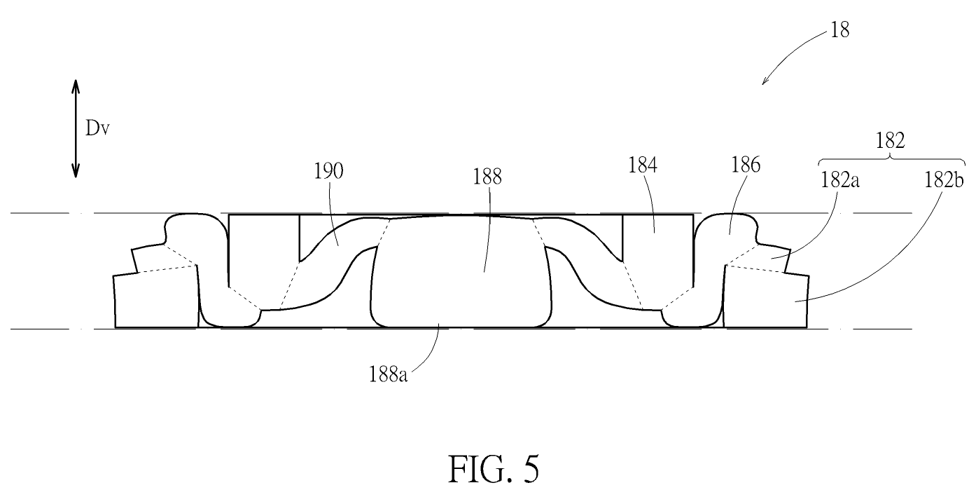

Please refer to FIG. 1 to FIG. 5; therein, FIG. 2 to FIG. 5 show the process of the elastic dome 18 being compressed by the keycap 10. In FIG. 2, the elastic dome 18 is not compressed. In FIG. 3, the elastic dome 18 is compressed until the trigger post 188 begins to contact the switch circuit board 16. In FIG. 4, the elastic dome 18 continues to be compressed until the inner oblique annular wall 190 begins to deform. In FIG. 5, the elastic dome 18 continues to be compressed into a depressed state. In an actual operation of the keyswitch structure 1, the user presses the keycap 10 to compress the elastic dome 18. When the elastic dome 18 begins to be compressed, the outer oblique annular wall 186 of the elastic dome 18 begins to deform and then bends, causing the top ring portion 184 (together with the trigger post 188 and the inner oblique annular wall 190) to move downwards relatively quickly until the distal portion 188a of the trigger post 188 begins to contact the switch circuit board 16 (as shown by FIG. 3). At this time, the force exerted by distal portion 188a on the switch circuit board 16 is limited and, in principle, insufficient to trigger the switch 162. Subsequently, the elastic dome 18 continues to be compressed, the outer oblique annular wall 186 continues to deform, and the trigger post 188 begins to deform. Shortly after deformation occurs in the trigger post 188 (especially in the distal portion 188a), the inner oblique annular wall 190 begins to deform noticeably. Subsequently, the elastic dome 18 continue to be compressed, and the outer oblique annular wall 186, the trigger post 188, and the inner oblique annular wall 190 all continue to deform; therein, the inner oblique annular wall 190 will first bend at the portion connected to the trigger post 188 (as shown by FIG. 4). This helps the trigger post 188 maintain its posture stability during subsequent compression, improving the reliability of the trigger post 188 in triggering the switch 162. Subsequently, the elastic dome 18 continues to be compressed until it reaches the depressed state (as shown by FIG. 5). At this time, the outer oblique annular wall 186 is elastically bent (in an S-shape) and (through the two bends of the S-shape) abuts against keycap 10 and (the switch circuit board 16 of) the base of the keyswitch structure 1, the keycap 10 does not contact the bottom ring portion 182, and the connection between the upper portion 182a and the lower portion 182b of the bottom ring portion 182 is higher than the connection between the top ring portion 184 and the top conical surface 1902 of inner oblique annular wall 190 in the vertical direction Dv.

Furthermore, during the deformation of the outer oblique annular wall 186, the outer oblique annular wall 186 will also drive the bottom ring portion 182 to deform, as shown by FIG. 3 to FIG. 5. When the elastic dome 18 is in the depressed state (as shown by FIG. 5), the elastically deformed portions of the elastic dome 18 store energy. When the elastic dome 18 returns to its original shape, this energy can be released and serves as the energy source to push the keycap 10 back to its original position. In the embodiment, a significant portion of the bottom ring portion 182 (including the upper portion 182a) participates in the elastic deformation of the elastic dome 18. Therefore, the pressed elastic dome 18 stores more energy than a typical rubber dome (whose bottom ring portion does not participate in elastic deformation), and can push the keycap 10 back to its original position with greater force and faster. This helps to improve the pressing tactile feel (e.g., in gaming scenarios).

In addition, in practice, once the trigger post 188 begins to contact the switch circuit board 16, the trigger post 188 is allowed to trigger the switch 162 (during the states of the elastic dome 18 shown by from FIG. 3 to FIG. 5). Furthermore, in practice, it is practicable to design the structure of the elastic dome 18 (including structural layout, dimensions, etc.) so that the trigger post 188 triggers the switch 162 in a specific state, such as between the states of the elastic dome 18 shown by from FIG. 4 to FIG. 5. Please refer to FIG. 2. In the embodiment, the elastic dome 18 has a total thickness H1 in the vertical direction Dv. The top ring portion 184 has a top ring thickness H2 in the vertical direction Dv. The bottom ring portion 182 has a bottom ring thickness H3 in the vertical direction Dv. The trigger post 188 has a post thickness H4 on the vertical direction Dv. The trigger post 188 has an outer diameter d1 at the connection between the trigger post 188 and the bottom conical surface 1904. The trigger post 188 has an outer diameter d2 at the connection between the trigger post 188 and the top conical surface 1902. The top ring portion 184 has an inner diameter d3 at the connection between the top ring portion 184 and the top conical surface 1902. For example, the ratio value of the outer diameter d1 to the outer diameter d2 is between 0.83 and 4.9, and can be further narrowed to between 2.4 and 2.6. The ratio value of the outer diameter d1 to the inner diameter d3 is between 0.37 and 0.65. The top ring thickness H2 is 28% to 34% of the total thickness H1. The bottom ring thickness H3 is 32% to 38% of the total thickness H1. The post thickness H4 is less than 45% of the total thickness H1. However, it is not limited thereto in practice.

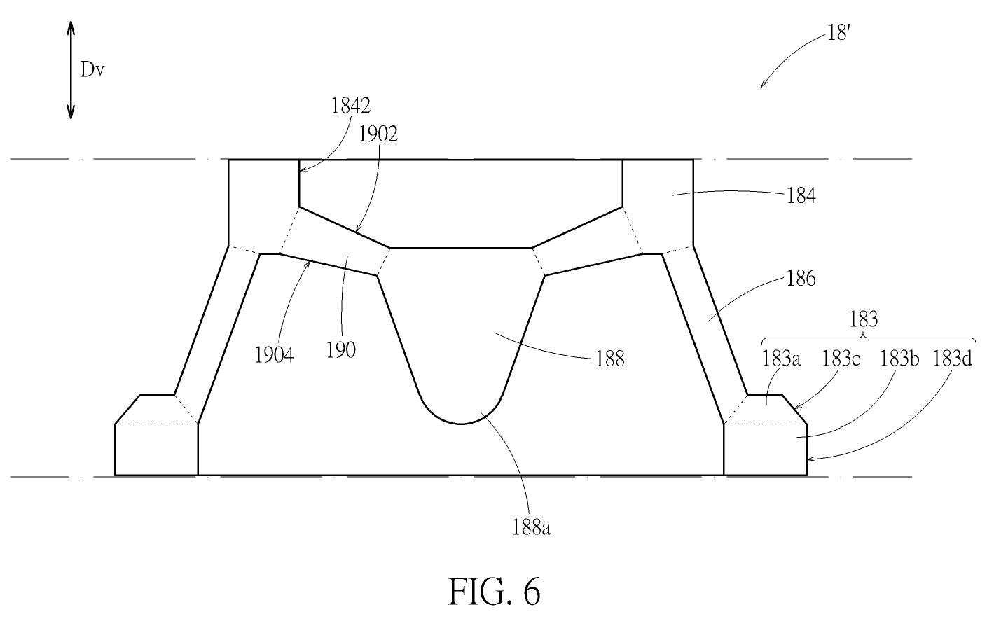

In addition, as shown by FIG. 2, in the embodiment, in the bottom ring portion 182, the upper portion 182a and the lower portion 182b form a step structure; that is, an outer surface 182c of the upper portion 182a and an outer surface 182d of the lower portion 182b are not directly connected to each other. However, it is not limited thereto in practice. For example, in a variation shown by FIG. 6, an elastic dome 18' is roughly the same as the elastic dome 18, and hence, uses the component symbols of the elastic dome 18 in principle. For other descriptions about the elastic dome 18', please refer to the relevant descriptions of the elastic dome 18, which will not be described in addition. A main difference between the elastic dome 18' and the elastic dome 18 is that in the elastic dome 18', the outer surface 183c of the upper portion 183a of the bottom ring portion 183 and the outer surface 183d of the lower portion 183b of the bottom ring portion 183 are directly interconnected. The upper portion 183a has a larger volume than the upper portion 182a of the elastic dome 18, and in principle, can provide greater energy storage (which is beneficial for pushing the keycap 10 back to its original position). Furthermore, in the variation, the outer surface 183c of the upper portion 183a is not limited to a straight line (based on the viewpoint of FIG. 6); for example, it can be modified to a curve. For another example, in the elastic dome 18, the upper portion 182a itself can also be modified into a step structure.

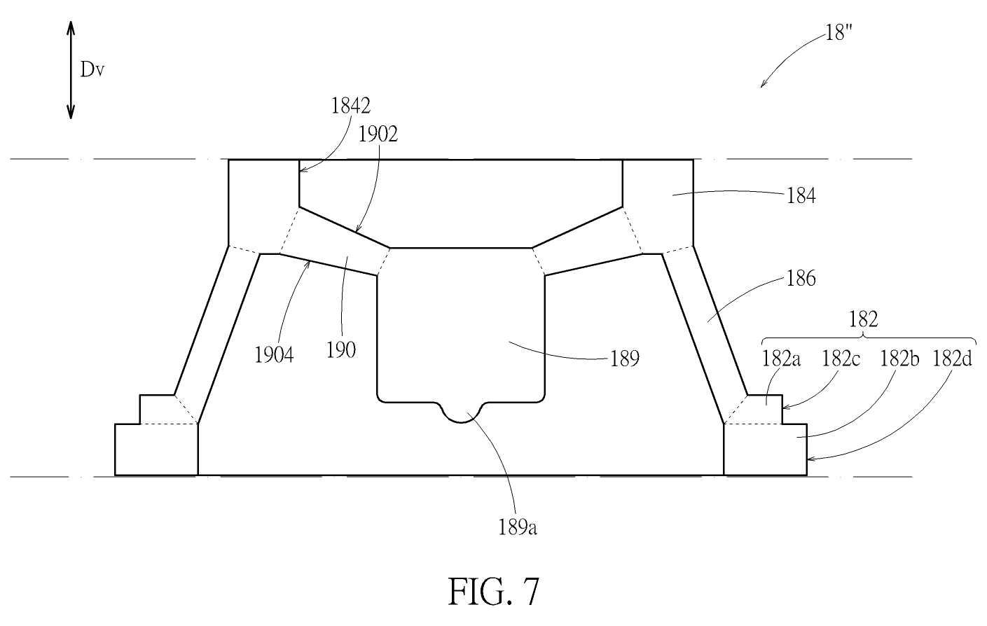

In addition, as shown by FIG. 2, in the embodiment, the trigger post 188 as a whole is a cone-shaped structure and has a narrowed distal portion 188a facing downwards. This cone-shaped structure allows the distal portion 188a to be easily elastically deformed, so that the switch 162 is not immediately triggered when it comes into contact with the trigger post 188; in other words, the triggering of the switch 162 can be delayed. However, it is not limited thereto in practice. For example, in a variation shown by FIG. 7, an elastic dome 18" is roughly the same as the elastic dome 18, and hence, uses the component symbols of the elastic dome 18 in principle. For other descriptions about the elastic dome 18", please refer to the relevant descriptions of the elastic dome 18, which will not be described in addition. A main difference between the elastic dome 18" and the elastic dome 18 is that the trigger post 189 of the elastic dome 18" as a whole is a cylindrical structure with a protrusion (defined as a distal portion 189a) at one end. The trigger post 189 triggers the switch through the discrete portion 189a. The degree to which the switch 162 is delayed can also be controlled by designing the shape of the distal portion 189a itself (e.g., the height of its protrusion from the end face of the trigger post 189), which will not be described further.

In addition, as shown by FIG. 2, in the embodiment, a distance H5 from the top of the trigger post 188 to the bottom surface of the keycap 10 (equivalent to the chain line in the figure) and a distance H6 from the distal portion 188a of the trigger post 188 to the top surface of the switch circuit board 16 (equivalent to the chain line in the figure) are both related to the timing of the trigger post 189 triggering the switch 162. In practice, a protruding column can be formed on the top of the trigger post 188 or the top of trigger post 188 protrudes upward relative to the inner oblique annular wall 190 (as shown by the dotted lines in FIG. 2), thus changing the distance H5. Similarly, modifying the degree to which the distal portion 188a of the trigger post 188 extends downward can also change the distance H6.

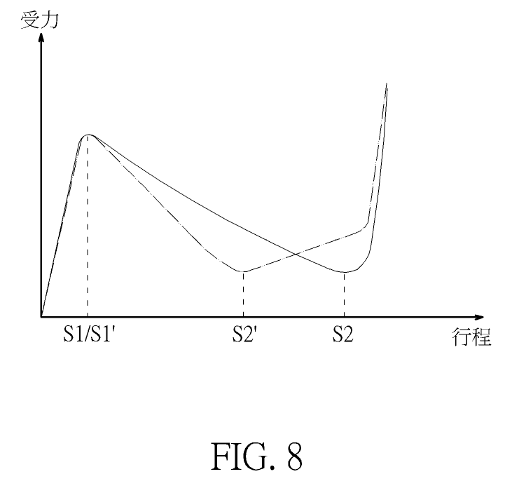

Please refer to FIG. 8, which is a schematic diagram illustrating a stress deformation curve of the elastic dome 18. Therein, the deformation is represented by the travel distance of the elastic dome 18 under the pressure of the keycap 10; the chain line in the figure represents a stress deformation curve of a typical rubber dome. A traveling position S1 corresponding to the peak of the curve of the elastic dome 18 is similar to a traveling position S1' corresponding to the peak of the curve of a general rubber dome, while a traveling position S2 corresponding to the valley of the curve of the elastic dome 18 is delayed relative to a traveling position S2' corresponding to the valley of the curve of the general rubber dome. The pressing tactile 5feel is generally similar to the travel distance difference corresponding to the peak and the valley. The difference in travel distance between the traveling position S2 and the traveling position S1 is greater than the difference in travel distance between the traveling position S2' and the traveling position S1'. Therefore, the elastic dome 18 of the embodiment can provide a significant pressing tactile feel. Furthermore, the trigger position of the general rubber protrusion is after the traveling position S2'. The user needs to press beyond the traveling position S2' to trigger the switch, which may result in the actual pressing operation failing to effectively trigger the switch. The trigger position of the elastic dome 18 of the embodiment is before traveling position S2, so each pressing operation can effectively trigger the switch 162.

As described above, the elastic dome 18 of the embodiment provides a better pressing tactile feel, a faster rebound and more effective triggering.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An elastic dome, used in a keyswitch structure, the elastic dome comprising:
a bottom ring portion, the bottom ring portion having a narrowed upper portion;
a top ring portion, the top ring portion being located above the bottom ring portion in a vertical direction;
an outer oblique annular wall, the outer oblique annular wall being located between the top ring portion and the bottom ring portion in the vertical direction, two ends of the outer oblique annular wall being connected to the top ring portion and the upper portion of the bottom ring portion;
a trigger post, the trigger post being located inside the outer oblique annular wall; and
an inner oblique annular wall, the inner oblique annular wall extending obliquely downward from an inner side of the top ring portion and being connected to the trigger post.

2. The elastic dome according to claim 1, wherein the bottom ring portion has a lower portion connected to the upper portion, and the upper portion and the lower portion form a step structure.

3. The elastic dome according to claim 1, wherein the bottom ring portion has a lower portion connected to the upper portion, and an outer surface of the upper portion is directly connected to an outer surface of the lower portion.

4. The elastic dome according to claim 1, wherein the inner oblique annular wall has a top conical surface and a bottom conical surface, and a connection between the top conical surface and the trigger post is higher than a connection between the bottom conical surface and the top ring portion in the vertical direction.

5. The elastic dome according to claim 1, wherein the inner oblique annular wall has a top conical surface and a bottom conical surface, and a ratio value of an outer diameter of the trigger post at a connection between the trigger post and the bottom conical surface to an outer diameter of the trigger post at a connection between the trigger post and the top conical surface is between 0.83 and 4.9.

6. The elastic dome according to claim 5, wherein the ratio value is between 2.4 and 2.6.

7. The elastic dome according to claim 1, wherein the trigger post has a narrowed distal portion facing downwards.

8. The elastic dome according to claim 1, wherein the inner oblique annular wall has a top conical surface and a bottom conical surface, and a ratio value of an outer diameter of the trigger post at a connection between the trigger post and the bottom conical surface to an inner diameter of the top ring portion at a connection between the top ring portion and the top conical surface is between 0.37 and 0.65.

9. An elastic dome, used in a keyswitch structure, the elastic dome comprising:
a bottom ring portion, the bottom ring portion having a narrowed upper portion and a lower portion connected to the upper portion;
a top ring portion, the top ring portion being located above the bottom ring portion in a vertical direction;
an outer oblique annular wall, the outer oblique annular wall being located between the top ring portion and the bottom ring portion in the vertical direction, two ends of the outer oblique annular wall being connected to the top ring portion and the upper portion of the bottom ring portion;
a trigger post, the trigger post being located inside the outer oblique annular wall; and
an inner oblique annular wall, the inner oblique annular wall extending obliquely downward from an inner side of the top ring portion and being connected to the trigger post, the inner oblique annular wall having a top conical surface;
wherein when the elastic dome is compressed to a depressed state by a keycap of the keyswitch structure, a connection between the upper portion and the lower portion is higher than a connection between the top ring portion and the top conical surface in the vertical direction.

10. The elastic dome according to claim 9, wherein when the elastic dome is in the depressed state, the outer oblique annular wall elastically bends and abuts against the keycap and a base of the keyswitch structure.

11. The elastic dome according to claim 10, wherein when the elastic dome is in the depressed state, the keycap does not touch the bottom ring portion.

12. An elastic dome, used in a keyswitch structure, the elastic dome comprising:
a bottom ring portion;
a top ring portion, the top ring portion being located above the bottom ring portion in a vertical direction;
an outer oblique annular wall, the outer oblique annular wall being located between the top ring portion and the bottom ring portion in the vertical direction, two ends of the outer oblique annular wall being connected to the top ring portion and the bottom ring portion;
a trigger post, the trigger post being located inside the outer oblique annular wall; and
an inner oblique annular wall, the inner oblique annular wall extending obliquely downward from an inner side of the top ring portion and being connected to the trigger post, the inner oblique annular wall having a maximum thickness at a portion connected to the top ring portion and a minimum thickness at a portion connected to the trigger post.

13. The elastic dome according to claim 12, wherein the inner oblique annular wall gradually thins from the top ring portion to the trigger post.

14. The elastic dome according to claim 12, wherein the outer oblique annular wall has an inclined angle relative to the vertical direction, and the inclined angle is between 15 degrees and 30 degrees.

15. The elastic dome according to claim 12, wherein the top ring portion has an inner wall surface, the inner oblique annular wall has a top conical surface, the inner wall surface and the top conical surface form an included angle, and the included angle is between 90 degrees and 180 degrees.

16. The elastic dome according to claim 12, wherein the elastic dome has a total thickness in the vertical direction, the top ring portion has a top ring thickness in the vertical direction, and the top ring thickness is 28% to 34% of the total thickness.

17. The elastic dome according to claim 12, wherein the elastic dome has a total thickness in the vertical direction, the bottom ring portion has a bottom ring thickness in the vertical direction, and the bottom ring thickness is 32% to 38% of the total thickness.

18. The elastic dome according to claim 12, wherein the elastic dome has a total thickness in the vertical direction, the trigger post has a post thickness in the vertical direction, and the post thickness is less than 45% of the total thickness.

19. The elastic dome according to claim 12, wherein the minimum thickness is greater than a wall thickness of the outer oblique annular wall.
